(19) United States
(12) Patent Application Publication
(10) Pub. No.: US 2008/0063438 A1
(43) Pub. Date: Mar. 13, 2008

(54) Developer regulating apparatus and developing unit and image forming apparatus having the same

(75) Inventor: Seung-gweon Lee, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/706,269

(22) Filed: Feb. 15, 2007

(30) Foreign Application Priority Data
Sep. 11, 2006 (KR) 2006-87686

(51) Int. Cl. G03G 15/08

(52) U.S. Cl. 399/284

(57) ABSTRACT

A developer regulating apparatus and a developing unit and image forming apparatus having the same. The developing unit includes a developing cartridge to accommodate a developer, a developing member disposed in the developing cartridge to face a photoconductor, and a developer regulating apparatus to regulate the developer of the developer member. The developer regulating apparatus includes a charging member to come in surface contact with the developing member and thus to charge the developer with electricity, a pressing member disposed to be pressed toward the developing member and to interpose the charging member therebetween, and a maintaining member to adjust and maintain a contact area between the charging member and the developing member.

### CROSS-REFERENCE TO RELATED APPLICATIONS

This application claims priority under 35 U.S.C. §119(a) of Korean Patent Application No. 10-2006-0087686 filed Sep. 11, 2006, in the Korean Intellectual Property Office, the entire disclosure of which is hereby incorporated by reference.

### BACKGROUND OF THE INVENTION

1. Field of the Invention

The present general inventive concept relates to an image forming apparatus, and more particularly, to a developer regulating apparatus, which regulates a developer of a developing member in a layer of predetermined thickness and charges it with electricity, and a developing unit and image forming apparatus having the same.

2. Description of the Related Art

Generally, an image forming apparatus, such as a copier, a printer, a facsimile, and a multifunction machine which performs functions of these as a single device, is provided with a developing unit, which forms a desired image on a printing medium. The developing unit includes a developing cartridge to accommodate a developer, and a developing member disposed in the developing cartridge to develop an electrostatic latent image of a photoconductor. Such a developing unit has a developer regulating apparatus for regulating the developer supplied onto the developing member in a layer of predetermined thickness and charging it with electricity.

FIG. 1 illustrates a general developer regulating apparatus of a developing unit. A regulating blade 3, as the developer regulating apparatus, is disposed coming in contact with a surface of a developing member 2, which faces a photoconductor 1. The regulating blade 3 regulates a developer supplied onto the developing member 2 in a layer of predetermined thickness. At this time, the regulating blade 3 is adhered to and fixed by a supporting member 4.

Also, the regulating blade 3 comes in contact with the developing member 2, so that it friction-charges the developer with a predetermined electric charge. The developer charged is adhered onto an electrostatic latent image of the photoconductor 1, and thus a desired image is formed.

A quality of the developer layer formed by the regulating blade 3 as described above is determined by a distance “a” from a contact point between the developing member 2 and the regulating blade 3 to a free end of the regulating blade 3 and a pressing force of the regulating blade 3 to the developing member 2. More specifically, the electrification of the developer by the regulating blade 3 is influenced by a contact area between the regulating blade 3 and the developing member 2 and the pressing force.

However, if the pressing force of the regulating blade 3 to the developing member 2 is too large, an excessive stress is imparted on the developer, thereby causing deterioration in image quality. To reduce the pressing force, a method of reducing a length of the regulating blade 3 or reducing an elastic deformation amount thereof can be considered, but it may result in problems, such as an obstacle to miniaturization of the developing unit and deterioration in image quality caused by an unevenness of the developer layer. Also, since the regulating blade 3 and the developing member 2 are in line contact with each other, a charging efficiency may be deteriorated.

### SUMMARY OF THE INVENTION

The present general inventive concept provides a developer regulating apparatus to increase a developer layer regulating efficiency and a charging efficiency without creation of an excessive stress on a developer, a developing unit having the same and an image forming apparatus having the same.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept are achieved by provided a developer regulating apparatus of an image forming device including a charging member to come in surface contact with a developing member, which faces a photoconductor, and thus to charge a developer with electricity, a pressing member disposed to be pressed toward the developing member and to interpose the charging member therebetween, and a maintaining member to adjust and maintain a contact area between the charging member and the developing member.

The charging member may include a thin film sheet formed, so that a tension is maintained by the maintaining member.

The charging member may have one end attached to a non-pressing surface of the pressing member to wrap a pressing end of the pressing member, and the another end fixed to the maintaining member.

The maintaining member may elastically urge the another end of the charging member against the developing member thus to adjust and maintain the contact area between the charging member and the developing member.

The maintaining member may include a leaf spring.

Alternatively, the maintaining member may include a compressive coil spring.

The foregoing and/or other aspects and utilities of the present general inventive concept may also be achieved by providing a developing unit of an image forming device including a developing cartridge to accommodate a developer, a developing member disposed in the developing cartridge to face a photoconductor, and a developer regulating apparatus to regulate the developer of the developer member in a layer of predetermined thickness and to charge the developer with electricity. The developer regulating apparatus includes a charging member to come in surface contact with the developing member and thus to charge the developer with electricity, a pressing member disposed to be pressed toward the developing member and to interpose the charging member therebetween, and a maintaining member to adjust and maintain a contact area between the charging member and the developing member.

The charging member may have one end fixed to the developing cartridge, and another end fixed to the maintaining member.

The developing unit may further include first and second supporting members to support the maintaining member and the pressing member to the developing cartridge, respectively.

The foregoing and/or other aspects and utilities of the present general inventive concept may also be achieved by providing a developing unit of an image forming apparatus including a charging member to charge a developer on a developing member facing a photoconductor, a pressing member to support one end of the charging member, and a maintaining member to support another end of the charging member.

The charging member may surface-contact the developing member.

The maintaining member may adjust and maintain the contact area between the charging member and the developing member.

The foregoing and/or other aspects and utilities of the present general inventive concept may also be achieved by providing an image forming apparatus including a photoconductor having an electrostatic latent image formed thereon, a developing unit to develop the electrostatic latent image with a developer, the developing unit including a developing cartridge to accommodate the developer, a developing member disposed in the developing cartridge to face the photoconductor, and a developer regulating apparatus to regulate the developer of the developing member in a layer of predetermined thickness and to charge the developer with electricity, the developer regulating apparatus further including a charging member to come in surface contact with a developing member, which faces a photoconductor, and thus to charge a developer with electricity, a pressing member disposed to be pressed toward the developing member and to interpose the charging member therebetween, and a maintaining member to adjust and maintain a contact area between the charging member and the developing member.

The foregoing and/or other aspects and utilities of the present general inventive concept may also be achieved by providing a method of forming an image with an image forming apparatus, the method including forming an electrostatic latent image on a photoconductor, and developing the electrostatic latent image with a developer, the developing of the electrostatic latent image including disposing a charging member to come in contact with a developing member which faces the photoconductor, thus charging the developer with electricity, disposing a pressing member to be pressed toward the developing member and to interpose the charging member therebetween, and controlling a maintaining member to adjust and maintain a contact area between the charging member and the developing member.

The foregoing and/or other aspects and utilities of the present general inventive concept may also be achieved by providing a developing unit of an image forming device, including a developing cartridge to contain a developer, a developing member disposed in the developer cartridge, a supporting member formed on the developer cartridge, a pressing member connected to a first end of the supporting member to be extended at a first angle toward a surface of the developing member, a maintaining member connected to a second end of the supporting member at a second angle different from the first angle, and a charging member having one end connected to the maintaining member, another end connected to the pressing member, and a middle portion formed between the one end and the another end to contact the surface of the developing member to regulate the developer.

The one end and the another end of the charging member may form a first angle and a second angle with respect to the middle portion of the charging member, respectively. The first angle may be an obtuse angle and the second angle may be an acute angle.

Other objects, advantages, and salient features of the general inventive concept will become apparent to those skilled in the art from the following detailed description, which, taken in conjunction with the annexed drawings, discloses the present general inventive concept.

### BRIEF DESCRIPTION OF THE DRAWINGS

These and/or other aspects and advantages of the present general inventive concept will become apparent and more readily appreciated from the following description of the embodiment, taken in conjunction with the accompanying drawings of which:

FIG. 1 is a cross-sectional view illustrating an example of a developing unit to which a general developer regulating apparatus is applied;

FIG. 2 is a cross-sectional view illustrating a developing unit of an image forming apparatus to which a developer regulating apparatus according to an embodiment of the present general inventive concept is applied;

FIG. 3 is a magnified cross-sectional view illustrating the developer regulating apparatus 50 of FIG. 2; and

FIG. 4 is an view illustrating a middle portion of the charging member of the developer regulating apparatus of FIG. 3.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

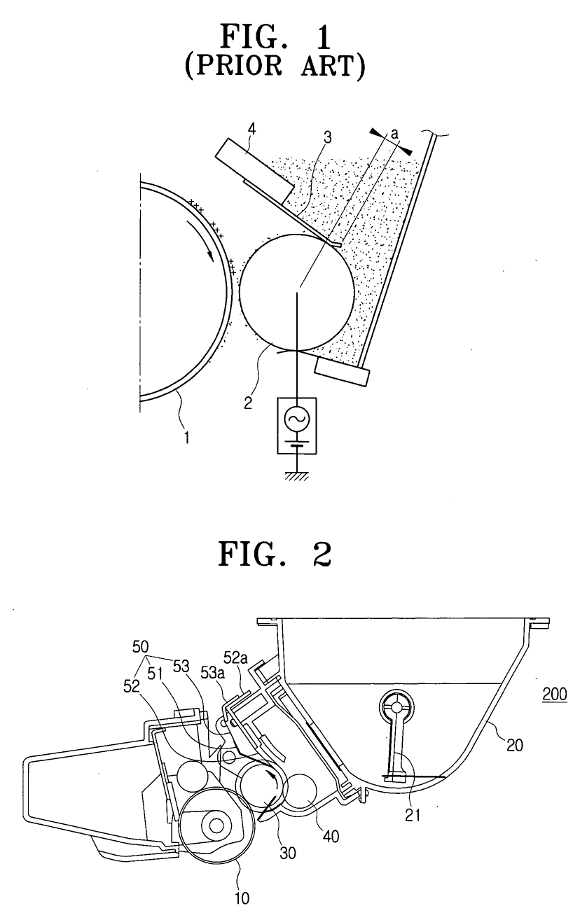

As illustrated in FIG. 2, a developing unit of an image forming apparatus 200 according to an embodiment of the present general inventive concept includes a developing cartridge 20, a developing member 30, and a developer regulating apparatus 50 since other elements of the image forming apparatus 200 are well known, detailed descriptions of the other elements will be omitted.

The developing cartridge 20 accommodates a developer, which develops an electrostatic latent image of a photoconductor 10. In the developing cartridge 20 is disposed an agitator 21 to agitate the developer.

The developing member 30 rotates facing the photoconductor 10, so that it attaches the developer onto the electrostatic latent image of the photoconductor 10. To supply the developer to the developing member 30, a supplying roller 40, which rotates coming in contact with the developing roller 30, is disposed in the developing cartridge 20 of the image forming apparatus 200.

The developer regulating apparatus 50, which regulates the developer of the developing member 30 in a layer of predetermined thickness and charges it with electricity, includes a charging member 51, a pressing member 52, and a maintaining member 53.

The charging member 51 comes in surface contact with the developing member 30 and thus charges the developer with electricity. Such a charging member 51 is formed of a thin film sheet of resin material, which is selected considering a polarity of the developer.

In an exemplary embodiment of the present general inventive concept, the developer has (−) polarity and the charging member 51 is a thin film sheet formed of a polyamide (PA) type material with a charging order, which is relatively (+), or a material with a charging order similar thereto. However, the present general inventive concept is not limited to those. For example, if the developer has (+) polarity, it goes without saying that the charging member 51 can be formed of a material with a relative (−) polarity.

To improve a charging property, the charging member 51 can be formed to include a conductive material, or can be applied with a predetermined voltage.

The charging member 51 is fixed at one end 51b to the pressing member 52 and at the other end 51a to the maintaining member 53, which will be described in detail later. The present general inventive concept is not limited to that, however. For example, the charging member 51 can be modified, so that the one end 51b thereof is fixed to the developing cartridge 20 in a vicinity of the developer regulating apparatus 50.

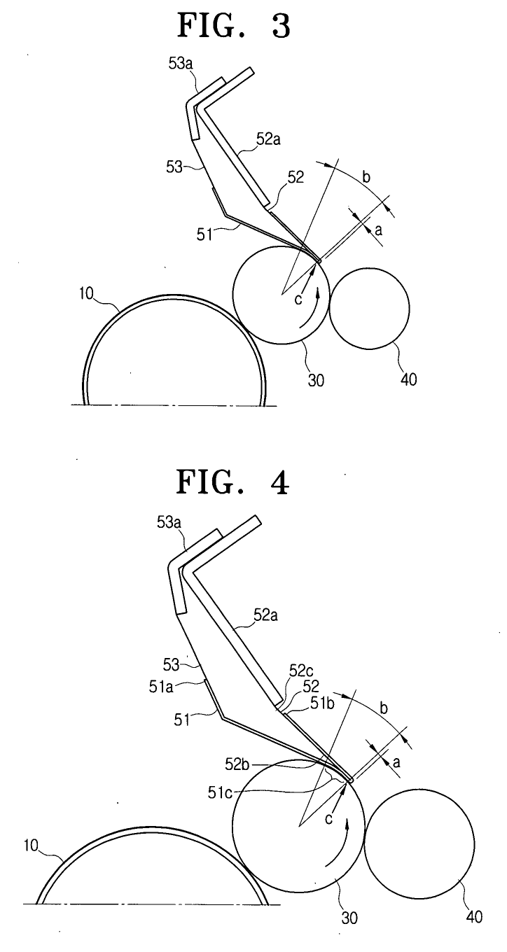

Referring to FIGS. 3 and 4, the pressing member 52 is pressed toward the developing member 30 while interposing the charging member 51 therebetween, that is, between the pressing member 52 and the developing member 30. One end 52b of the pressing member 52 is a free end pressed toward the developing member 30, whereas the other end 52c of the pressing member 52 is a fixed end fixed to a first supporting member 52a thus to be supported by the developing cartridge 20. With this construction, the pressing member 52 is elastically urged toward the developing member 30 like a kind of leaf spring. As illustrated in FIG. 4, the charging member 51 includes a middle portion 51c between the one end 51b and the other end 51a which is in contact with the developing member 30. The charging member 51 may be a folded structure.

Also, as illustrated in FIGS. 3 and 4, the pressing member 52 comes in line contact with the developing member 30 through the charging member 51, so that the charging member 51 has a predetermined length “a” from a contact point “c” between the charging member 51 and the developing member 30 to a tip of the free end 52b thereof. Accordingly, a developer amount is regulated on the developing member 30 by the predetermined length “a” from the contact point “c” between the developing member 30 and the charging member 51 to the tip of the free end 52b of the pressing member 52. The pressing member 52 may be made up of a blade of metal material, such as stainless steel, phosphor bronze, beryllium or the like, and is formed to have a thickness of approximately 0.05 mm-0.2 mm so as to provide a proper elastic pressing force.

The one end 52b, that is, the free end of the pressing member 52 is wrapped by the one end 51b of the charging member 51. The one end 51b of the charging member 51 is adhered and fixed to a non-pressing surface of the pressing member 52, which does not contact the developing member 30, by adhering means, such as an adhesive. The other end 51a of the charging member 51 is fixed to the maintaining member 53.

As illustrated in FIGS. 3 and 4, the maintaining member 53 adjusts and maintains a predetermined contact area “b” between the charging member 51 and the developing member 30 at the middle portion 51c of the charging member 51. Such a maintaining member 53 supports the other end 51a of the charging member 51, so that it urges the charging member 51 against the developing member 30.

The other end 51a of the charging member 51 is adhered and fixed to the maintaining member 53. The maintaining member 53 is fixed to a second supporting member 53a which is supported by the developing cartridge 20. With this construction, the maintaining member 53 acts as a kind of leaf spring like the pressing member 52, and thus maintains a tension of the charging member 51 at a portion 51c by use of an elastic pressing force.

To be more specific, the one end 51b and the other end 51a of the charging member 51 are urged against the developing member 30 by the pressing member 52 and the maintaining member 53, respectively, so that the charging member 51 can maintain a predetermined tension between the pressing member 52 and the maintaining member 53.

As illustrated in FIGS. 3 and 4, due to a construction of the charging member 51, the predetermined contact area “b” is formed between the charging member 51 and the developing member 30 by a pressing force from the maintaining member 53. Also, the pressing member 52, which supports the one end 51b of the charging member 51, also maintains a pressing force toward the developing member 30 by the maintaining member 53, so that a contact state between the developing member 30 and the charging member 51 can be uniformly maintained.

As the charging member 51 comes in surface contact with the developing member 30 at the middle portion 51c while having the uniformly maintained contact state at the predetermined contact area “b” as described above, a charging time of the developer is increased, and thus charging and maintaining properties are improved.

According to a printing environment, the predetermined contact area “b” between the developing member 30 and the charging member 51 and the elastic pressing force of the pressing member 52 can be changed by varying the elastic force of the maintaining member 53 supported by the second supporting member 53a.

Hereinafter, an operation of the developing unit having the developer regulating apparatus constructed as described above will be described in detail with reference to FIGS. 2, 3, and 4.

As illustrated in FIG. 2, a developer accommodated in the developer cartridge 20 is supplied to the developing member 30 through the supplying roller 40. At this time, the charging member 51, which is pressed by the pressing member 52 while maintaining a tension by the maintaining member 53, is in a state where it contacts the developing member 30 with the predetermined contact area “b”.

According to this, an amount of the developer supplied to the developing member 30 is regulated by the distance “a” from the contact point “c” between the developing member 30 and the pressing member 52 to the free end 52b of the pressing member 52, and thus a developer layer of predetermined thickness is formed on the developing member 30. Also, the developer regulated in the layer of the predetermined thickness is friction-charged with a predetermined electric charge by the predetermined contact area “b” between the developing member 30 and the charging member 51 at the middle portion 51c of the charging member 51.

The developer regulated in the layer of the predetermined thickness and charged with the predetermined electric charge as described above moves to and adheres onto an electrostatic latent image of the photoconductor 10, which faces the developing member 30, thus to develop the electrostatic latent image.

At this time, the predetermined contact area “b” between the developing member 30 and the charging member 51 can be adjusted and maintained by the maintaining member 53.

As apparent from the foregoing description, according to the present general inventive concept, the developer regulating apparatus and the developing unit and image forming apparatus having the same can adjust and maintain a contact area between the charging member and the developing member through the maintaining member. Accordingly, a toner charging performance can be expected to improve even with a low pressing force. Thus, toner stress is reduced, and an image quality can be improved. Also, since a charging property can be adjusted, various developers, such as a developer with a low melting point which is weak to stress, can be used in the image forming apparatus.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A developer regulating apparatus of an image forming apparatus comprising:
a charging member to come in surface contact with a developing member, which faces a photoconductor, and thus to charge a developer with electricity;
a pressing member disposed to be pressed toward the developing member and to interpose the charging member therebetween; and
a maintaining member to adjust and maintain a contact area between the charging member and the developing member.

2. The apparatus of claim 1, wherein the charging member comprises a thin film sheet formed, so that a tension is maintained by the maintaining member.

3. The apparatus of claim 2, wherein the charging member has one end attached to a non-pressing surface of the pressing member to wrap a pressing end of the pressing member, and another end fixed to the maintaining member.

4. The apparatus of claim 3, wherein the maintaining member elastically urges the another end of the charging member against the developing member thus to adjust and maintain the contact area between the charging member and the developing member.

5. The apparatus of claim 4, wherein the maintaining member comprises a leaf spring.

6. The apparatus of claim 4, wherein the maintaining member comprises a compressive coil spring.

7. A developing unit of an image forming apparatus comprising:
a developing cartridge to accommodate a developer;
a developing member disposed in the developing cartridge to face a photoconductor; and
a developer regulating apparatus to regulate the developer of the developing member in a layer of predetermined thickness and to charge the developer with electricity,
the developer regulating apparatus comprising:
a charging member to come in surface contact with the developing member and thus to charge the developer with electricity,
a pressing member disposed to be pressed toward the developing member and to interpose the charging member therebetween, and
a maintaining member to adjust and maintain a contact area between the charging member and the developing member.

8. The unit of claim 7, wherein the charging member comprises a thin film sheet formed so that a tension is adjusted and maintained by the maintaining member.

9. The unit of claim 8, wherein the charging member has one end attached to a non-pressing surface of the pressing member to wrap a pressing end of the pressing member, and another end fixed to the maintaining member.

10. The unit of claim 8, wherein the charging member has one end fixed to the developing cartridge, and another end fixed to the maintaining member.

11. The unit of claim 9, wherein the maintaining member elastically urges the another end of the charging member against the developing member thus to adjust and maintain the contact area between the charging member and the developing member.

12. The unit of claim 11, wherein the maintaining member comprises a leaf spring.

13. The unit of claim 11, wherein the maintaining member comprises a compressive coil spring.

14. The unit of claim 7, further comprising:
first and second supporting members to support the maintaining member and the pressing member to the developing cartridge, respectively.

15. A developing unit of an image forming apparatus, comprising:
a charging member to charge a developer on a developing member facing a photoconductor;
a pressing member to support one end of the charging member; and
a maintaining member to support another end of the charging member.

16. The unit of claim 15, wherein the charging member surface-contacts the developing member.

17. The unit of claim 15, wherein the maintaining member adjusts and maintains the contact area between the charging member and the developing member.

18. An image forming apparatus comprising:
a photoconductor having an electrostatic latent image formed thereon;
a developing unit to develop the electrostatic latent image with a developer, the developing unit comprising:
a developing cartridge to accommodate the developer,
a developing member disposed in the developing cartridge to face the photoconductor, and
a developer regulating apparatus to regulate the developer of the developing member in a layer of predetermined thickness and to charge the developer with electricity, the developer regulating apparatus further comprising:
a charging member to come in surface contact with a developing member, which faces a photoconductor, and thus to charge a developer with electricity;
a pressing member disposed to be pressed toward the developing member and to interpose the charging member therebetween; and
a maintaining member to adjust and maintain a contact area between the charging member and the developing member.

19. A method of forming an image with an image forming apparatus, the method comprising:
forming an electrostatic latent image on a photoconductor; and
developing the electrostatic latent image with a developer, the developing of the electrostatic latent image comprising:
disposing a charging member to come in contact with a developing member which faces the photoconductor, thus charging the developer with electricity;
disposing a pressing member to be pressed toward the developing member and to interpose the charging member therebetween; and
controlling a maintaining member to adjust and maintain a contact area between the charging member and the developing member.

20. A developing unit of an image forming device, comprising:
a developing cartridge to contain a developer;
a developing member disposed in the developer cartridge;
a supporting member formed on the developer cartridge;
a pressing member connected to a first end of the supporting member to be extended at a first angle toward a surface of the developing member;
a maintaining member connected to a second end of the supporting member at a second angle different from the first angle; and
a charging member having one end connected to the maintaining member, another end connected to the pressing member, and a middle portion formed between the one end and the another end to contact the surface of the developing member to regulate the developer.

21. The developing unit of claim 20, wherein the one end of the charging member overlaps with the maintaining member, and the another end of the charging member overlaps with the pressing member.

22. The developing unit of claim 20, wherein the one end of the charging member has an overlap area with the maintaining member, and the another end of the charging member has another overlap area with the pressing member, the overlap area being larger than the another overlap area.

23. The developing unit of claim 20, wherein the middle portion of the charging member comprises a folded portion having both ends extended from the one end and the another end, respectively.

24. The developing unit of claim 20, wherein the middle portion of the charging member comprises a first portion having the same shape of the surface of the developing member on a second portion to contact the surface to regulate and charge the developer attached to the developing member.

25. The developing unit of claim 20, wherein the one end and the another end forms form a first angle and a second angle with respect to the middle portion, respectively.

26. The developing unit of claim 25, wherein the first angle is an obtuse angle and the second angle is an acute angle.

27. The developing unit of claim 20, wherein the one end of the charging member comprises a portion attached to the second portion of the maintaining member, and another portion bent from the portion toward the middle portion of the charging member.

28. The developing unit of claim 20, wherein the middle portion of the charging member is lifted up from the surface of the developing member by the developer and is pressed forward to the developing member to adjust a thickness of the developer.

29. The developing unit of claim 20, wherein the charging member is maintained in a contact area with the developing member by a pressing force of the pressing member.

30. The developing unit of claim 20, wherein the pressing member comprises:
a blade of metal material.

31. The developing unit of claim 30, wherein the pressing member is one of stainless steel, phosphor bronze, and beryllium.

32. The developing unit of claim 31, wherein the pressing member has a thickness of approximately 0.05 mm-0.2 mm.
